(19) United States
(12) Patent Application Publication
(10) Pub. No.: US 2025/0383675 A1
(43) Pub. Date: Dec. 18, 2025

(54) Powered Gas Shutoff Valve Assembly

(71) Applicant: Mike Frost, Brantford (CA)

(72) Inventor: Mike Frost, Brantford (CA)

(21) Appl. No.: 18/741,349

(22) Filed: Jun. 12, 2024

(51) Int. Cl. G05D 7/06; F17D 5/00

(52) U.S. Cl. CPC G05D 7/0629; F17D 5/005

(57) ABSTRACT

A powered gas shutoff valve assembly includes a shutoff valve, an actuator, a control system, and a power source to supply power to the control system and the actuator. The shutoff valve includes a passage, a valve seat, and a valve member movable into and out of engagement with the valve seat to close and open the passage. The actuator is operatively connected to the valve member to move the valve member. The control system includes a control unit and a gas detection sensor operatively connected to the control unit. The control unit is operatively connected to the actuator to permit selective or automatic activation of the actuator to close the passage when the gas detection sensor detects the presence of harmful gas in the surrounding environment at or above a selected threshold.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to gas shutoff valves and more particularly pertains to a new powered gas shutoff valve assembly to permit selective or automatic closing of the gas shutoff valve when a gas detection sensor detects presence of harmful gas in the surrounding environment at or above a selected threshold. Such harmful gases include carbon monoxide, natural gas, and smoke. The powered gas shutoff valve assembly can shut off flow of gas in hazardous or emergency situations, such as gas leaks or fires, to prevent or mitigate loss of life and damage to property.

### (2) Description of Related Art Including Information Disclosed Under 37 CFR 1.97 and 1.98

The prior art relates to gas shutoff valves. The prior art, as best understood, does not disclose a powered gas shutoff valve assembly to permit selective or automatic activation of an actuator to close a passage when a gas detection sensor detects the presence of harmful gas in the surrounding environment at or above a selected threshold.

### BRIEF SUMMARY OF THE INVENTION

An embodiment of the disclosure meets the needs presented above in a powered gas shutoff valve assembly generally comprising a shutoff valve, an actuator, a control system, and a power source to supply power to the control system and the actuator. The shutoff valve includes a passage, a valve seat, and a valve member movable into and out of engagement with the valve seat to close and open the passage. The actuator is operatively connected to the valve member to move the valve member. The control system includes a control unit and a gas detection sensor operatively connected to the control unit. The control unit is operatively connected to the actuator to permit selective or automatic activation of the actuator to close the passage when the gas detection sensor detects the presence of harmful gas in the surrounding environment at or above a selected threshold.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a powered gas shutoff valve assembly according to an embodiment of the disclosure.

FIG. 2 is a cross-sectional view of an embodiment of the disclosure.

FIG. 3 is a view of an embodiment of the disclosure in a first use.

FIG. 4 is a view of an embodiment of the disclosure in a second use.

FIG. 5 is a view of an embodiment of the disclosure in a third use.

FIG. 6 is a view of an embodiment of the disclosure in a fourth use.

FIG. 7 is a block diagram of an embodiment of the disclosure.

### DETAILED DESCRIPTION OF THE INVENTION

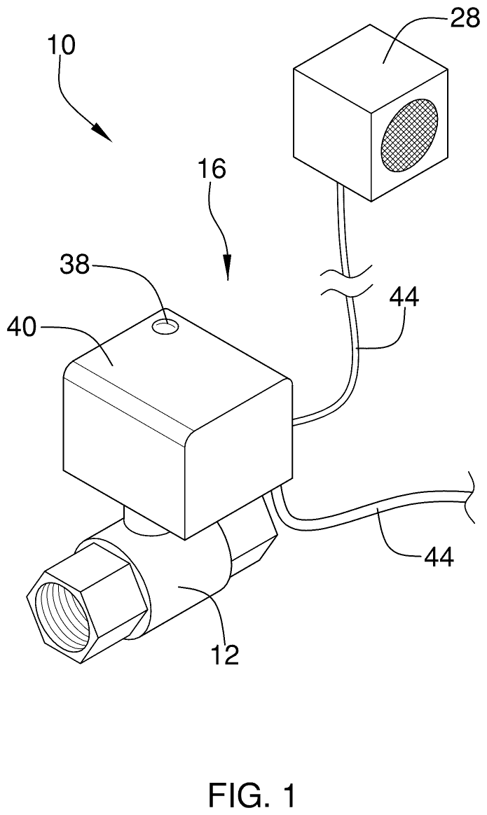

With reference now to the drawings, and in particular to FIGS. 1 through 7 thereof, a new powered gas shutoff valve assembly embodying the principles and concepts of an embodiment of the disclosure and generally designated by the reference numeral 10 will be described.

As best illustrated in FIGS. 1 through 7, the powered gas shutoff valve assembly 10 generally comprises a shutoff valve 12, an actuator 14, a control system 16, and a power source 18 to supply power to the control system 16 and the actuator 14. The shutoff valve 12 includes a passage 20, a valve seat 22, and a valve member 24 movable into and out of engagement with the valve seat 22 to close and open the passage 20. The actuator 14 is operatively connected to the valve member 24 to move the valve member 24. The control system 16 includes a control unit 26 and a gas detection sensor 28 operatively connected to the control unit 26. The control unit 26 is operatively connected to the actuator 14 to permit selective or automatic activation of the actuator 14 to close the passage 20 when the gas detection sensor 28 detects the presence of harmful gas in the surrounding environment at or above a selected threshold.

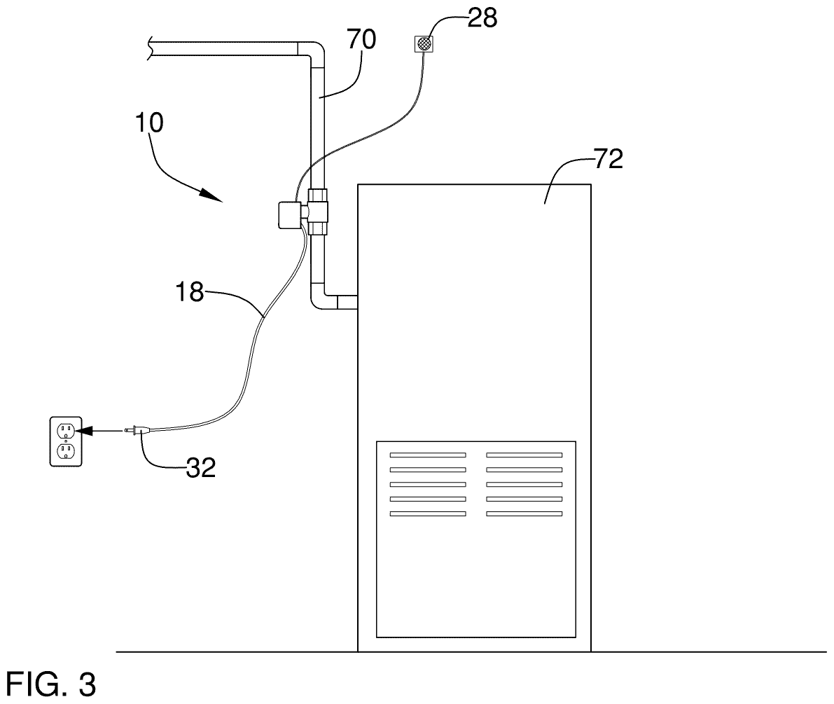

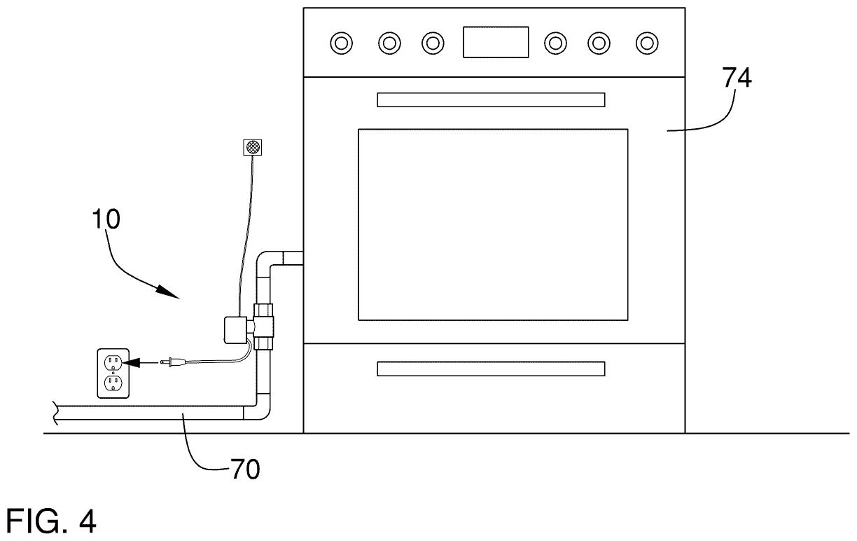

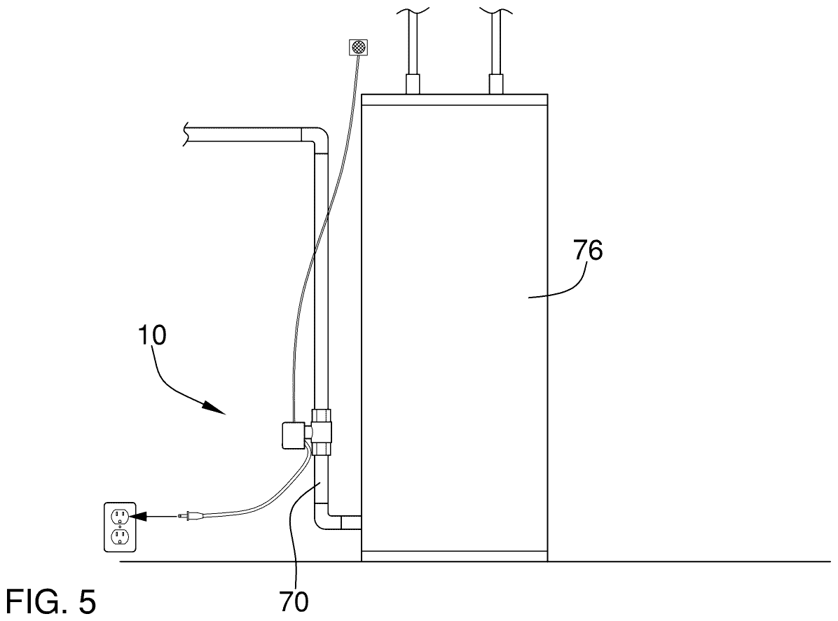

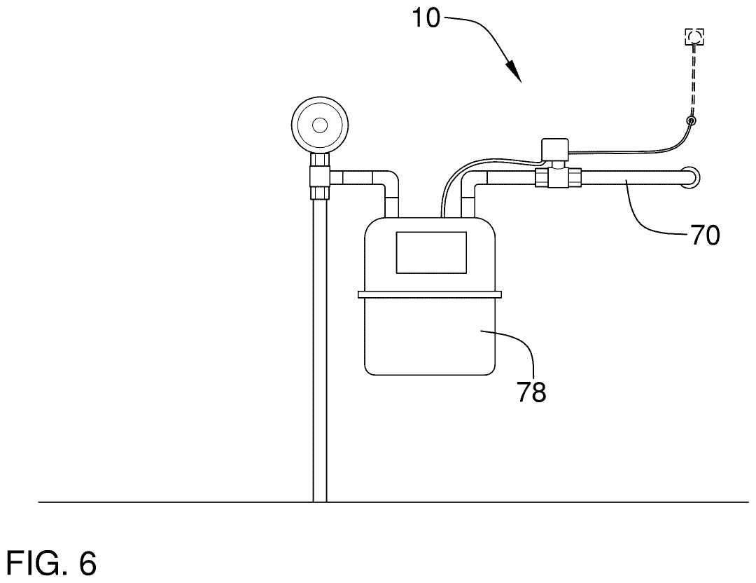

The shutoff valve 12 is connectable to any gas line including gas lines for appliances, heating units, and buildings. For example, FIG. 3 shows the shutoff valve 12 connected to a gas line 70 to a furnace 72, FIG. 4 shows the shutoff valve 12 connected to a gas line 70 to a gas oven or stove 74, FIG. 5 shows the shutoff valve 12 connected to a gas line 70 to a hot water tank 76, and FIG. 6 shows the shutoff valve 12 connected to a main gas line 70 from the gas meter 78 entering into a building. The actuator 14 itself could be of most any design, though a solenoid 30 could be utilized. The power source 18 could be a wired power source 18, such as a plug 32 to a wall outlet as shown in FIG. 3, for example, or could be a battery.

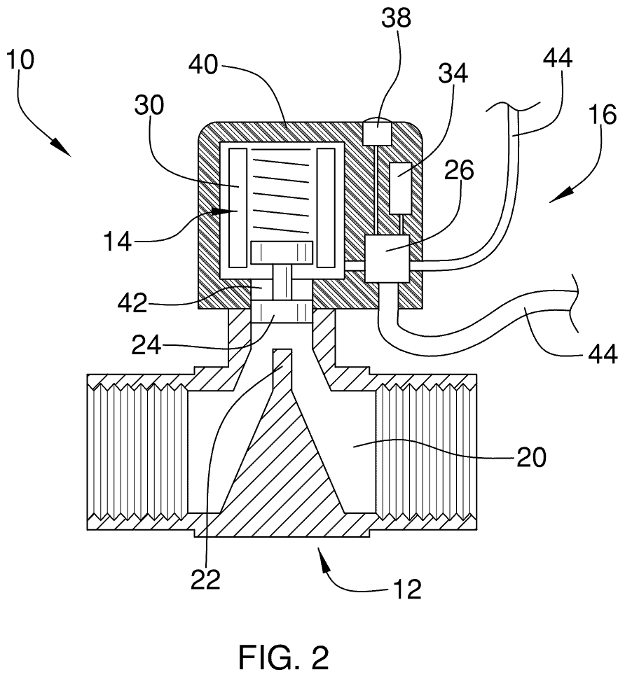

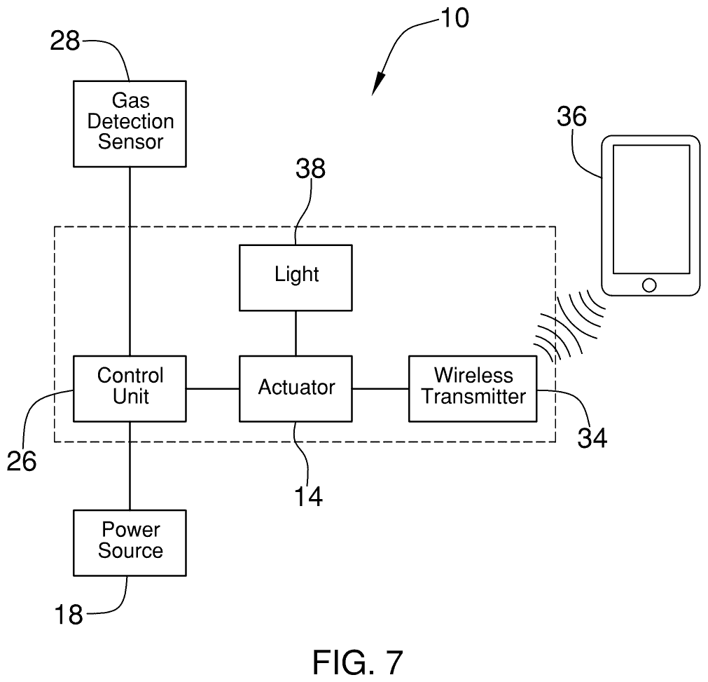

The control unit 26, which could be a microprocessor or a power switch, can be designed for fully automatic operation, fully manual or selective operation by a user, or a combination of both. For example, the control unit 26 could be designed to automatically activate the actuator 14 when the gas detection sensor 28 detects the presence of harmful gas in the surrounding environment at or above a selected threshold, as measured by any standard, such as parts per million. This could be accomplished by programming the control unit 26 to evaluate information received from the gas detection sensor 28 and determine whether or not to close the shutoff valve 12, or by setting the gas detection sensor 28 to send a signal that automatically activates the control unit 26 to close the shutoff valve 12. Alternatively or in addition, the control system 16 could include a wireless transmitter 34, as shown in FIGS. 2 and 7, operatively connected to the control unit 26 and designed to transmit information between the control unit 26 and an electronic remote control device 36 to permit selective closure of the passage 20 by a user. For example, the user could have a computer application or app on a smartphone or other electronic device that receives information via the wireless transmitter 34 regarding the operation of the powered gas shutoff valve assembly 10, such as the presence or level of harmful gas detected by the gas detection sensor 28. At the user's discretion, the user can choose whether or not to activate the powered gas shutoff valve assembly 10 and close the shutoff valve 12. For example, the application could be set to show any levels or presence of harmful gases, which may or may not be at a level considered to be dangerous or hazardous, and thus the user can opt not to close the shutoff valve 12. Alternatively, the application could be set to only notify the user of dangerous levels, and thus encourage the user to close the shutoff valve 12. The application could further be programmed to automatically close the shutoff valve 12 once a certain level is reaches without input from the user. The control system 16 could also include a light 38 operatively connected to the control unit 26 to indicate operating status of the control system 16. For example, the light 38 could show that the control unit 26 is on or off or the shutoff valve 12 is open or closed, or could have different colors to indicate different statuses, such as one color for a safe condition and another color for an unsafe condition.

In the exemplary embodiment shown in FIGS. 1 and 2, a housing 40 is mounted on the shutoff valve 12. The housing 40 contains the actuator 14, the control unit 26, the wireless transmitter 34, and the light 38. The valve member 24 is movable into and out of the housing 40 via an orifice 42 in the housing 40. The gas detection sensor 28 and the power source 18 are connected to the control unit 26 by wires 44 at a distance from the housing 40. In one possible embodiment, the gas detection sensor 28 could be connected wirelessly via the wireless transmitter 34. As shown in FIGS. 3, 4, 5, and 6, the gas detection sensor 28 can be mounted somewhere near the gas line 70 to be controlled. However, the gas detection sensor 28 could essentially be mounted anywhere, such as rooms inside a building where people may be present but gas-powered appliances are not. For example, in FIG. 6, the gas detection sensor 28 is mounted inside a building while the gas shutoff valve 12 is mounted outside the building. In another possible embodiment, there could be multiple gas detection sensors 28 in multiple locations but all operatively connected to the gas shutoff valve 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A powered gas shutoff valve assembly comprising:
a shutoff valve comprising a passage, a valve seat, and a valve member movable into and out of engagement with said valve seat to close and open said passage, said valve seat having a lower section and an upper protrusion, said lower section having a conical cross-sectinoal shape, said upper protrusion extending upwardly from an apex of said lower section, said upper protrusion being positioned within a gap in a peripheral wall of said passage;
an actuator operatively connected to said valve member to move said valve member;
a control system comprising a control unit and a gas detection sensor operatively connected to said control unit, wherein said control unit is operatively connected to said actuator to permit selective or automatic activation of said actuator to close said passage when said gas detection sensor detects the presence of harmful gas in the surrounding environment at or above a selected threshold; and
a power source to supply power to said control system and said actuator.

2. The powered gas shutoff valve assembly of claim 1, wherein said control unit is configured to automatically activate said actuator when said gas detection sensor detects the presence of harmful gas in the surrounding environment at or above a selected threshold.

3. The powered gas shutoff valve assembly of claim 1, wherein said control system comprises a wireless transmitter operatively connected to said control unit and configured to transmit information between said control unit and an electronic remote control device to permit selective closure of said passage by a user.

4. The powered gas shutoff valve assembly of claim 1, wherein said control system comprises a light operatively connected to said control unit to indicate operating status of said control system.

5. The powered gas shutoff valve assembly of claim 1, wherein said shutoff valve is connectable to any gas line including gas lines for appliances, heating units, and buildings.

6. The powered gas shutoff valve assembly of claim 1, wherein said actuator comprises a solenoid.

7. A powered gas shutoff valve assembly comprising:
a shutoff valve comprising a passage, a valve seat, and a valve member movable into and out of engagement with said valve seat to close and open said passage, wherein said shutoff valve is connectable to any gas line including gas lines for appliances, heating units, and buildings, said valve seat having a lower section and an upper protrusion, said lower section having a conical cross-sectinoal shape, said upper protrusion extending upwardly from an apex of said lower section, said upper protrusion being positioned within a gap in a peripheral wall of said passage;
an actuator operatively connected to said valve member to move said valve member, wherein said actuator comprises a solenoid;
a control system comprising a control unit and a gas detection sensor operatively connected to said control unit, wherein said control unit is operatively connected to said actuator to permit selective activation of said actuator to close said passage when said gas detection sensor detects the presence of harmful gas in the surrounding environment at or above a selected threshold, wherein:
said control system comprises a wireless transmitter operatively connected to said control unit and configured to transmit information between said control unit and an electronic remote control device to permit selective closure of said passage by a user,
said control system comprises a light operatively connected to said control unit to indicate operating status of said control system;
a power source to supply power to said control system and said actuator; and
a housing mounted on said shutoff valve, wherein said housing contains said actuator, said control unit, said wireless transmitter, and said light, and wherein said valve member is movable into and out of said housing via an orifice in said housing, and wherein said gas detection sensor and said power source are connected to said control unit by wires at a distance from said housing.

8. A powered gas shutoff valve assembly comprising:
a shutoff valve comprising a passage, a valve seat, and a valve member movable into and out of engagement with said valve seat to close and open said passage, wherein said shutoff valve is connectable to any gas line including gas lines for appliances, heating units, and buildings, said valve seat having a lower section and an upper protrusion, said lower section having a conical cross-sectinoal shape, said upper protrusion extending upwardly from an apex of said lower section, said upper protrusion being positioned within a gap in a peripheral wall of said passage;
an actuator operatively connected to said valve member to move said valve member, wherein said actuator comprises a solenoid;
a control system comprising a control unit and a gas detection sensor operatively connected to said control unit, wherein said control unit is operatively connected to said actuator to permit automatic activation of said actuator to close said passage when said gas detection sensor detects the presence of harmful gas in the surrounding environment at or above a selected threshold, wherein:
said control unit is configured to automatically activate said actuator when said gas detection sensor detects the presence of harmful gas in the surrounding environment at or above a selected threshold,
said control system comprises a light operatively connected to said control unit to indicate operating status of said control system;
a power source to supply power to said control system and said actuator; and
a housing mounted on said shutoff valve, wherein said housing contains said actuator, said control unit, and said light, and wherein said valve member is movable into and out of said housing via an orifice in said housing, and wherein said gas detection sensor and said power source are connected to said control unit by wires at a distance from said housing.
